(19) United States
(12) Patent Application Publication
(10) Pub. No.: US 2009/0080979 A1
(43) Pub. Date: Mar. 26, 2009

(54) SYSTEM AND METHOD FOR DECONTAMINATING SOIL AND GROUNDWATER

(75) Inventor: Carl Nick Zehler, White, GA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Fruits & Associates, Inc., Acworth, GA (US)

(21) Appl. No.: 12/235,009

(22) Filed: Sep. 22, 2008

Related U.S. Application Data
(60) Provisional application No. 60/974,263, filed on Sep. 21, 2007.

(51) Int. Cl. B09C 1/02

(52) U.S. Cl. 405/128.3

(57) ABSTRACT

A system for decontaminating a soil and groundwater region. The system has a well manifold assembly comprising a conduit adapted to be inserted into a contaminated area of the soil and groundwater region, a vacuum system for withdrawing fluid and vapor from the soil and groundwater region, and a remediating fluid injection system in fluid connection with the conduit. The remediating fluid injection system is adapted to inject a remediating fluid into the soil and groundwater region for treating contaminants in the soil and groundwater region. The conduit is linked to both the remediating fluid injection system and to the vacuum system. The vacuum system is operated to perform a dual-phase extraction of fluid and vapor from the soil and groundwater region to create a negative pressure in the soil and groundwater region. Next, remediating fluid is injected into the soil and groundwater region.

### CROSS-REFERENCE TO RELATED APPLICATION

This Application claims the benefit of U.S. Provisional Patent Application No. 60/974,263, filed Sep. 21, 2007. The entire disclosure of the above-referenced provisional application is incorporated herein by reference for all purposes as if presented herein in its entirety.

### BACKGROUND OF THE DISCLOSURE

The present disclosure generally relates to a system and a method for removing contaminants from soil and groundwater.

Various contaminants can be found in a contaminated subsurface zone, including in the groundwater and soil. Such contaminants can include hydrocarbon compounds from various sources of contaminations, for example, leaking underground storage tanks, industrial, and manufacturing operations, chemical storage in process areas, chemical spills, waste disposal areas, etc. Common contaminants from these sources include trichloroethylene (TCE), perchloroethylene (PCE), petroleum hydrocarbons such as benzene, and toluene, ethylbenzene, xylene, gasoline, diesel fuel, fuel oil, jet fuel, and others. Contaminants can exist in subsurface soil and in groundwater, below the water table, in various phases as discrete substances and mixed with and/or dissolved in groundwater and gases located in the soil. Such contaminants can occur in the vapor phase in the vadose (unsaturated) zone, in the free (separate) phase floating on top of the groundwater, or dense non-aqueous phase liquid (DNAPL) at the base of an aquifer, in a dissolved phase in the groundwater, and/or in an absorbed phase in the unsaturated (vadose) zone and saturated groundwater zone below the water table.

A number of techniques are known for removal of soil contaminants and remediation of affected soil. One such technique involves the excavation and treatment of the soil on-site or off-site by means such as incineration, chemical treatment, or biological treatment. Another technique involves saturating the contaminated soil with water in-situ (soil flushing), causing the contaminants to be slowly leached from the soil by the water. The contaminated water can then be removed. Other common methods include groundwater pumping and treatment, and air sparging.

Vacuum extraction techniques have also been proposed for removing contaminants from soil. For example, known soil vapor vacuum extraction methods include the extraction of volatile vapors from the soil subsurface above the resting water table, thereby extracting contaminants in vapor form that are present in the vadose zone.

Dual-phase or multi-phase extraction and vacuum-only extraction are other techniques for removing contaminants from soil and ground water. Such extraction methods result in the extraction of volatile vapors and liquids from the soil. Known methods for dual/multi-phase extraction include the extraction of subsurface liquid and vapor as a dual-phase (liquid and vapor) stream using a single vacuum pump, and the extraction of the subsurface liquid and soil vapor separately using two or more vacuum pumps.

The treatment of a contaminated soil and groundwater region with an oxidizing agent, biological agent, surfactant, co-solvent, and/or other materials and categories of materials also is known. For example, known soil and groundwater decontamination systems have a separate injection well for injecting a remediating fluid for treating the soil in the soil and groundwater region and a separate extraction well for extracting liquids and vapors from the soil and groundwater region.

### SUMMARY OF THE DISCLOSURE

In one aspect, the disclosure is generally directed to a system for decontaminating a soil and groundwater region. The system comprises a well manifold assembly comprising a conduit adapted to be inserted into a contaminated area of the soil and groundwater region, a vacuum system including a vacuum pump in fluid connection with the conduit for withdrawing fluid and vapor from the soil and groundwater region, and a remediating fluid injection system in fluid connection with the conduit. The remediating fluid injection system is adapted to inject a remediating fluid into the soil and groundwater region for treating contaminants in the soil and groundwater region. The conduit is linked to both the remediating fluid injection system accommodating a flow of the remediating fluid injected in a first direction into the soil and groundwater region and to the vacuum system for accommodating a flow of the fluid and vapor withdrawn from the soil and groundwater region in a second direction.

In another aspect, the disclosure is generally directed to a method of decontaminating a soil and groundwater region. The method comprises providing a well manifold assembly comprising a conduit inserted into the soil and groundwater region, a vacuum system in fluid connection with the conduit, and a remediating fluid injection system in fluid connection with the conduit. The vacuum system is operated to perform a dual-phase extraction of fluid and vapor from the soil and groundwater region comprising drawing fluid and vapor from the soil and groundwater region into and through the conduit, and creating a negative pressure in the soil and groundwater region. After withdrawing an amount of fluid and vapor and creating the negative pressure in the soil and groundwater region, a remediating fluid is injected from the remediating fluid injection system into the soil and groundwater region. The remediating fluid is conveyed through the conduit and dispersed into the soil and groundwater region by the negative pressure created in the soil and groundwater region.

Other aspects, features, and details of the present disclosure can be more completely understood by reference to the following detailed description of exemplary embodiments taken in conjunction with the drawings and from the appended claims.

Those skilled in the art will appreciate the above stated advantages and other advantages and benefits of various additional embodiments reading the following detailed description of the embodiments with reference to the below-listed drawing figures. Further, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a schematic illustration of a soil and groundwater decontamination system according to one embodiment of the present disclosure.

FIG. 2 is a schematic illustration of the system of FIG. 1 illustrating an extraction stage of operation of the system.

FIG. 3 is a schematic illustration of the system of FIG. 1 illustrating an injection stage of operation of the system.

FIG. 4 is a schematic illustration of a vacuum system according to one embodiment of the disclosure.

Corresponding parts are designated by corresponding reference numbers throughout the drawings.

### DETAILED DESCRIPTION OF THE EXEMPLARY EMBODIMENTS

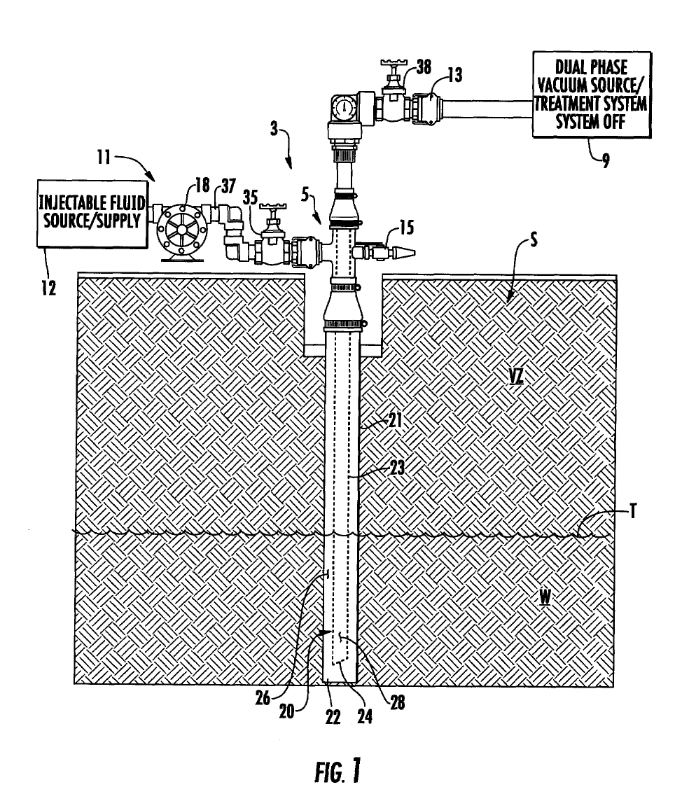

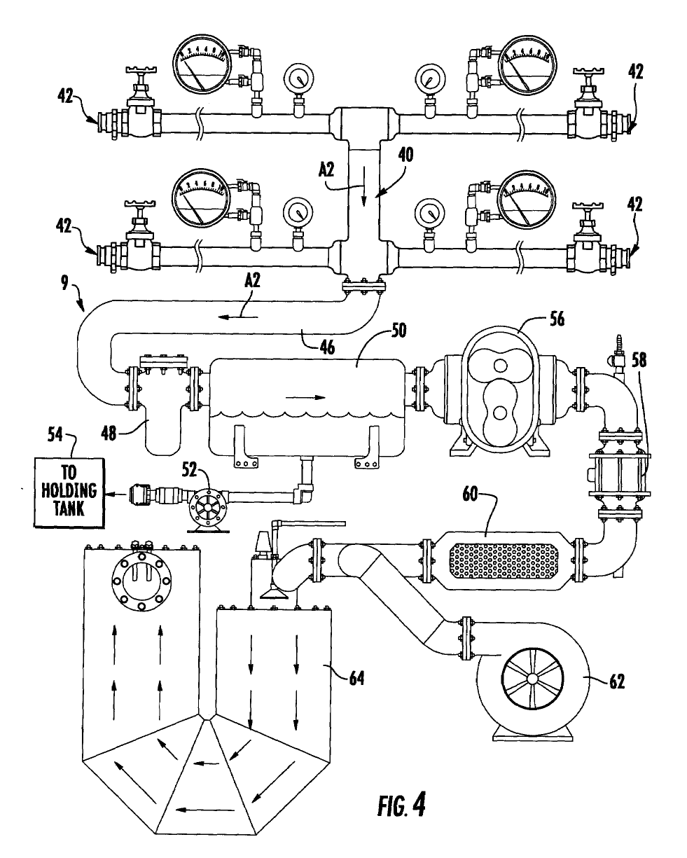

FIG. 1 illustrates a soil and groundwater decontamination system 3 according to one embodiment of the disclosure for removal of hydrocarbons and other contaminants or pollutants at an underground site of a soil and groundwater region S. The system 3 includes a well manifold assembly 5 that is connected to a vacuum system 9, an example embodiment of which is shown in FIG. 4. In the illustrated embodiment of the ground water decontamination system 3 shown in FIGS. 1-3, the vacuum system 9 is a dual-phase extraction system that is operated to extract air and water from the subsurface of the soil and groundwater region S to be decontaminated. In the illustrated embodiment, the well manifold assembly 5 can be connected to a remediating fluid injection system 11 that includes a pump 18 that supplies remediating fluid from a source 12 of suitable remediating fluid media (e.g., oxidizing agent, biological agent, surfactant, co-solvent, various combinations thereof, and/or any other suitable fluid) to the soil and groundwater region S via the well manifold assembly, fluid piping 37, valve 35, and other suitable valves, fittings, connectors, etc., for delivering the remediating fluid. As will be discussed below, in one embodiment of the disclosure, the remediating fluid media is introduced into the soil and groundwater region S after a negative pressure has been created by evacuation of the soil and groundwater region via the vacuum system 9. The optional pump 18 is available to provide pressure to the system and prevent backflow of the extracted fluid into the well manifold assembly 5.

As shown in FIG. 1, the well manifold assembly 5 generally includes a fitting 13 for connection to the vacuum system 9, a valve 38, an optional bleed air valve 15, and a conduit 20 extending into the soil and groundwater region S. In the illustrated embodiment, the conduit 20 comprises an outer tube or well casing 21 and a drop tube 23 co-axially positioned inside the well casing 21. The well manifold assembly 5 also generally is positioned relative to the ground so that the well casing 21 and drop tube 23 both extend into the soil and groundwater region S of the soil region to be decontaminated. As shown in FIG. 1, the well casing 21 and drop tube 23 can extend through the vadose zone VZ of the soil and groundwater region S and into the water table W of the soil region to be decontaminated.

As shown in FIG. 1, the conduit 20 includes a first chamber 26 through which the remediating fluid can flow along the conduit and a second chamber 28 within the conduit, which enables the flow of fluids and vapors for extraction from the water table by the vacuum system 9. The second chamber 28 comprises the radially inner portion of the conduit 20 defined by the drop tube 23, while the first chamber 26 comprises the radially outer portion of the conduit 20 and is defined by the space between the well casing 21 and the drop tube 23.

In the illustrated embodiment, the well casing 21 can be an elongated cylindrical pipe made of any suitable material (e.g., polyvinyl chloride (PVC), galvanized steel, carbon steel, stainless steel, etc.). In the illustrated embodiment, the well casing 21 further typically includes perforations along the length of the well casing. In one embodiment, the well casing 21 has a distal end 22 and the drop tube 23 has a distal opening 24 that is spaced above the distal end of the well casing and, as shown in FIG. 1, in an initial setup or starting illustration, the top level T of the water table W generally will be located above the distal end of the well casing 21. The drop tube 23 and well casing 21 could be otherwise shaped, designed, and oriented without departing from this disclosure.

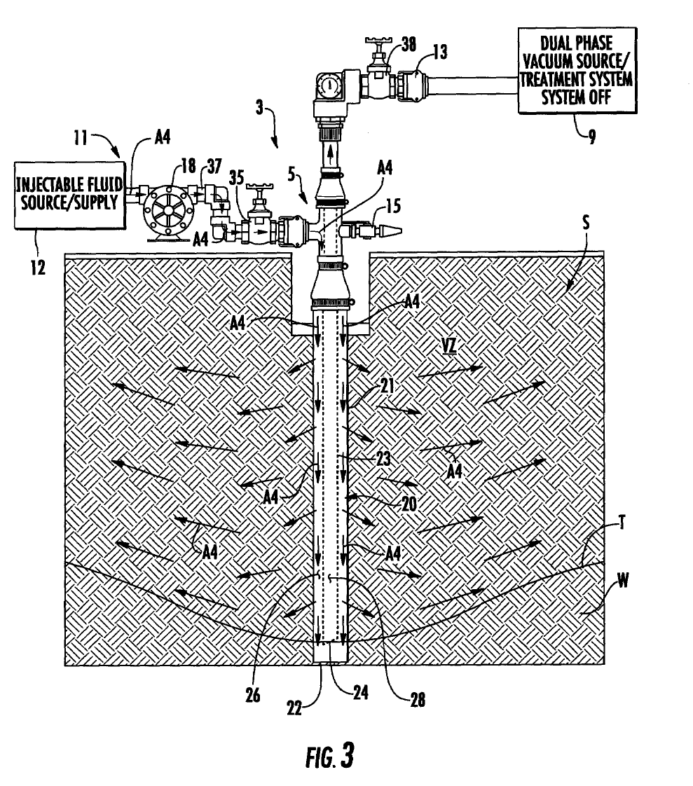

The first chamber 26 of the conduit 20 is in fluid communication with the remediating fluid injection system 11, which supplies a flow of remediating fluid media (e.g., oxidizing agent, biological agent, surfactant, co-solvent, etc.) that is directed through the well manifold assembly 5 and into the soil and groundwater region S as shown in FIG. 3. The source 12 of remediating fluid 11 is connected to the well manifold assembly 5 via fluid piping 37. A valve 35 (e.g., a manually-operated ball valve, slide valve, or other suitable valve) connects the fluid piping 37 to the well manifold assembly 5 to enable selective control of the flow of remediating fluid passing into the well casing 21. In the illustrated embodiment, the remediating fluid supply system 11 includes an optional pump 18 that supplies remediating fluid from the source or reservoir 12 of remediating fluid to the well manifold assembly 5. The first chamber 26 is also in fluid communication with the bleed air valve or port 15 which allows a controlled amount or flow of air or other fluid media under atmospheric pressure to enter the well casing. Alternatively, the air or other fluid media introduced through the bleed air valve 15 could be pressurized without departing from this disclosure. Typically, air will be allowed to enter the first chamber 26 through the bleed air valve 15 when the vacuum system 9 is operated to assist with the conveying of solid, liquid, and or gas from the soil and groundwater region S by the vacuum system. Alternatively, the vacuum system 9 can be operated without the introduction of air through the bleed air valve 15 without departing from this disclosure.

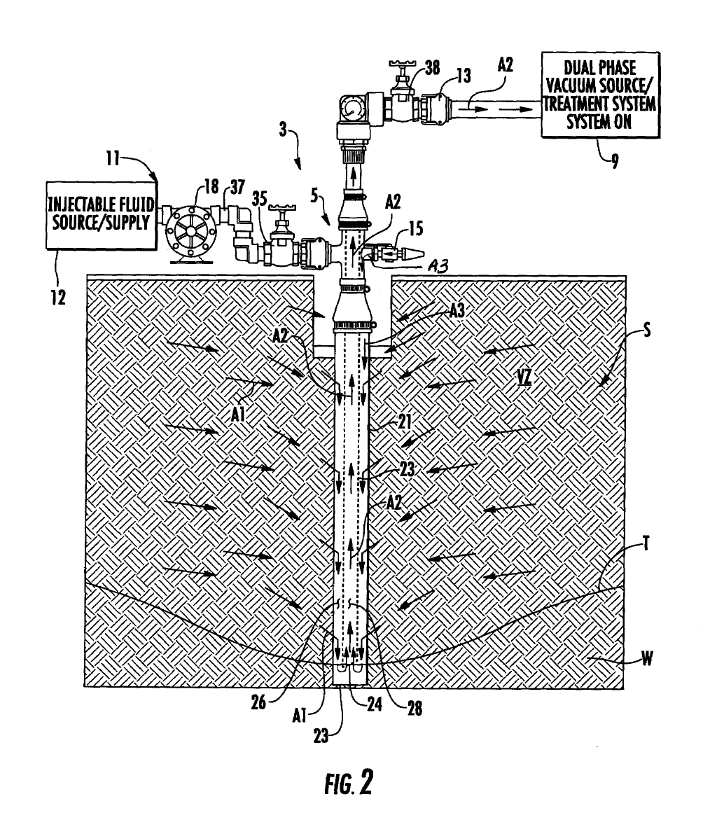

As FIGS. 1-3 illustrate, the drop tube 23 is preferably an elongated cylindrical pipe disposed internal to and extending longitudinally along the well casing 21. The drop tube 23 can be made from any suitable material (e.g., polyvinyl chloride (PVC), galvanized steel, carbon steel, stainless steel, etc.). In the illustrated embodiment, the drop tube 23 includes a distal opening 24 at its distal end that is located above the distal opening 22 of the well casing 21. The drop tube 23 further is in fluid communication with the vacuum system 9 as indicated in FIGS. 1-2.

In use, in a first operational stage, the vacuum system 9 initially is first operated as shown in FIG. 2 to create a negative pressure within the vadose zone VZ of the soil and groundwater region S. During the operation of the vacuum system 9, also referred to as a dual-phase vacuum extraction operation, fluid and vapors from the soil and groundwater region around the well casing 21 generally will be drawn into the first chamber 26 as generally indicated by arrows A1. The fluids and vapors flow downwardly along the first chamber 26 and into the distal opening 24 of the drop tube 23. As indicated by arrows A2, the fluids and vapors further are withdrawn through second chamber 28 of the drop tube 23 in one common stream flowing upwardly in the conduit 20. The withdrawn fluid and vapors are drawn through chamber 28 into the vacuum system 9, which can include filtration and treatment/remediation components for treating (i.e., decontaminating, filtering, etc.) the extracted fluids and vapors prior to storage and/or disposal. As shown in FIG. 2, the withdrawal of fluids and vapors by the operation of the vacuum system 9 tends to draw down the top surface T of the water table W in the soil and groundwater region S to a level close to that of the distal opening 24 of the drop tube 23. Further, as shown in FIG. 2, the air bleed valve 15 can be opened during the dual-phase extraction to allow air, indicated by arrow A3 to enter the first chamber 26 and assist with conveying the fluid and vapors from the soil and groundwater region S into the vacuum system 9.

After completion of the initial fluid/vapor extraction, the soil in the soil and groundwater region S proximate to the well manifold assembly 5 is under negative pressure. The valve 38 is closed to isolate the components of the vacuum system 9 from the well manifold assembly. As shown in FIG. 3, a remediating fluid (e.g., an oxidizing agent, biological agent, surfactant, co-solvent, and/or various combinations thereof, or other suitable fluids) is introduced into the soil and groundwater region S by opening the valve 35. The remediating fluid flows downwardly via gravity and the negative pressure created in the soil and groundwater region S through the first chamber 26 of the conduit 20 as indicated by arrows A4 shown in FIG. 3, and into the soil and groundwater region S. In one embodiment, the optional pump 18 can be operated at pressures of up to approximately 20 psi to assist in applying the remediating fluid from the source of remediating fluid 12. The negative pressure created in the soil and groundwater region S as a result of the dual-phase extraction process (FIG. 2) causes the remediating fluid that is introduced via the conduit 20 to be substantially dispersed into the soil and groundwater region. To further enhance the dispersion of remediating fluid in the soil and groundwater region S, the remediating fluid can be supplied to the well manifold assembly 5 at an increased pressure (e.g., by the optional pump 18).

After the remediating fluid is injected and dispersed into the soil and groundwater region S, the fluid is typically allowed time to mix and react with the contaminants in the soil. Reaction times of the remediating fluid with the contaminants vary dependent upon the remediating fluid supplied to the soil and groundwater region S and the amount and type of contaminants in the soil and groundwater region. After the injected fluid has sufficiently mixed and/or reacted with the contaminants, the vacuum system 9 can be re-engaged and operated to initiate a further dual-phase extraction (FIG. 2) in a similar manner as indicated and described above for FIG. 2. The second dual-phase extraction operation removes the reaction end products and remaining contaminant vapors and fluid from the soil and groundwater region S. Typically, the time delay between injecting the remediating fluid and reengaging the vacuum system 9 can vary from a few days to a few weeks, or more, depending on the type of remediating fluid and the amount and type of contaminants in the soil and groundwater region. Further, the same or a different vacuum system 9 having the same or different components can be used to perform the second dual-phase extraction operation.

FIG. 4 shows a vacuum system 9 that can be connected to one or more of the well manifold assemblies 5. The vacuum system 9 includes branchline piping 40 having four couplings 42 that are suitable for connection to a fitting 13 of a respective well manifold assembly 5. The vacuum system 9 can include less than four couplings 42 or more than four couplings without departing from the disclosure. The branchline piping 40 is connected to a header that is connected to a filter 48 (e.g., a four inch inline pipe strainer basket type filter) for removing particulate from the flow stream. A scrubber/knockout tank assembly 50 is downstream from the filter 48 and is sized to remove water from the flow stream. In one embodiment, the tank assembly 50 is a 25 gallon tank with appropriate controls and float switches. A contact water transfer pump 52 is in fluid connection with the tank assembly 50 and pumps water from the tank assembly to a holding tank 54 for further treatment and/or evaluation. In one embodiment, the transfer pump 52 is a 1 hp explosion proof transfer pump sized for a flow rate of up to approximately 15 gallons per minute (gpm), and the holding tank 54 is a 1,000 gallon poly tank, a 2000 gallon stainless truck tank, or a 6000 gallon aluminum tanker. Alternatively, the transfer pump 52 can pump water into any water treatment system, or any other type of holding tank. A vacuum pump 56 is located downstream from the scrubber/knockout tank assembly 50 which allows for separation of liquids and vapors. In one embodiment, the vacuum pump 56 is a 30 HP Rotary Lobe Pump that is sized for 600 cubic feet/min maximum flow capacity at approximately 25″ Hg vacuum. The vacuum pump 56 could be other types of vacuum pumps or blowers (e.g., liquid ring pumps, rotary claw, etc.) or could be otherwise sized and located without departing from the disclosure. The outlet of the vacuum pump 56 is connected to a spark arrestor 58 that prevents any combustion within the flow downstream from the vacuum pump. A muffler 60 is located downstream from the spark arrestor 58. An air blower 62 is provided to add combustion air to the flow downstream of the muffler 60. A thermal oxidizer 64 is located downstream from the air blower 62 and is for cleaning the vapor that is conveyed by the vacuum system 9 by burning contaminants that remain in the vapor stream that enters the oxidizer. In one embodiment, the thermal oxidizer 64 is a 7 million BTU/hour Thermal Oxidizer Unit that provides a hydrocarbon destruction rate of up to approximately 60 gallons per hour. The vacuum system 9 could include more or less than the components listed herein, the components could be otherwise arranged and configure, or the vacuum system may include different components than what are illustrated and described herein.

In the illustrated embodiment, the remediating fluid injection system 11 includes an optional pump 18 that may be used to assist in supplying remediating fluid from a source or reservoir 12 of suitable remediating fluid. The remediating fluid injection system 11 could include other suitable components for delivering the remediating fluid to the well manifold assembly 5 without departing from the disclosure. The remediating fluid could include an oxidizing agent, a biological agent, a surfactant, a co-solvent, various combinations thereof, and/or any other suitable chemical or other fluid that is suitable for treating soil and groundwater to assist in the removal of contaminants from the soil and groundwater.

The foregoing description illustrates and describes various embodiments of the present disclosure. As various changes could be made in the above construction, it is intended that all matter contained in the above description or shown in the accompanying drawings shall be interpreted as illustrative and not in a limiting sense. Furthermore, the present disclosure covers various modifications, combinations, alterations, etc., of the above-described embodiments. Additionally, the disclosure shows and describes only selected embodiments, but various other combinations, modifications, environments, changes, and/or modifications are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

It also will be understood by those skilled in the art that while the present disclosure has been discussed above with reference to exemplary embodiments, various additions, modifications and changes can be made thereto without departing from the spirit and scope of the claims.

What is claimed is:

1. A system for decontaminating a soil and groundwater region, the system comprising:
a well manifold assembly comprising a conduit adapted to be inserted into a contaminated area of the soil and groundwater region;
a vacuum system including a vacuum pump in fluid connection with the conduit for withdrawing fluid and vapor from the soil and groundwater region; and
a remediating fluid injection system in fluid connection with the conduit, the remediating fluid injection system is adapted to inject a remediating fluid into the soil and groundwater region for treating contaminants in the soil and groundwater region,
wherein the conduit is linked to both the remediating fluid injection system accommodating a flow of the remediating fluid injected in a first direction into the soil and groundwater region and to the vacuum system for accommodating a flow of the fluid and vapor withdrawn from the soil and groundwater region in a second direction.

2. The system of claim 1 wherein the conduit comprises a first chamber along which the flow of remediating fluid is injected into the soil and groundwater region and a second chamber through which the flow of fluid and vapor is withdrawn from the soil and groundwater region.

3. The system of claim 2 wherein the remediating fluid injected into the soil and groundwater region flows downwardly in the first chamber and the fluid and vapor withdrawn from the soil and groundwater region flows upwardly in the second chamber.

4. The system of claim 2 wherein the conduit comprises an outer pipe and an inner pipe, the outer and inner pipe being co-axially positioned relative to one another.

5. The system of claim 4 wherein the first chamber is defined within a space between the inner and outer pipe, and wherein the second chamber is defined along the inner pipe.

6. The system of claim 4 wherein the outer pipe comprises a plurality of openings formed along at least a portion of the outer pipe.

7. The soil and groundwater decontamination system of claim 4 wherein the inner pipe comprises a distal opening and the outer pipe comprises a distal end of the conduit, the distal opening being axially located above the distal end of the conduit.

8. The soil and groundwater decontamination system of claim 7 wherein the distal opening of the inner pipe is positioned below a water level of the water table and the distal opening of the outer pipe is positioned below the water level of the water table.

9. The soil and groundwater decontamination system of claim 1 wherein the remediating fluid comprises at least one of an oxidizing agent, a biological agent, a surfactant, and a co-solvent.

10. A method of decontaminating a soil and groundwater region, the method comprising:
providing a well manifold assembly comprising a conduit inserted into the soil and groundwater region, a vacuum system in fluid connection with the conduit, and a remediating fluid injection system in fluid connection with the conduit;
operating the vacuum system to perform a dual-phase extraction of fluid and vapor from the soil and groundwater region comprising drawing fluid and vapor from the soil and groundwater region into and through the conduit, and creating a negative pressure in the soil and groundwater region;
after withdrawing an amount of fluid and vapor and creating the negative pressure in the soil and groundwater region, injecting a remediating fluid from the remediating fluid injection system into the soil and groundwater region, the remediating fluid being conveyed through the conduit and dispersed into the soil and groundwater region by the negative pressure created in the soil and groundwater region.

11. The method of claim 10 wherein the conduit comprises a first chamber for receiving the flow of remediating fluid and a second chamber for receiving the flow of fluid and vapor from the soil and groundwater region.

12. The method of claim 11 wherein the operating the vacuum system comprises drawing fluid and vapor from the soil and groundwater region into the first chamber, directing the fluid and vapor along the first chamber to an opening of the second chamber, and passing the fluid and vapor through the second chamber to the vacuum system.

13. The method of claim 10 further comprising allowing the remediating fluid injected into the substrate to mix and react with contaminants in the soil and groundwater region to treat the soil and groundwater and assist in removal of contaminants from the soil and groundwater region.

14. The method of claim 13 further comprising reengaging the vacuum system after the allowing the remediating fluid to mix and react with the contaminants to remove the remediating fluid and vapor from the soil and groundwater region.

15. The method of claim 10 wherein the remediating fluid comprises at least one of an oxidizing agent, a biological agent, a surfactant, and a co-solvent.

16. The method of claim 10 wherein the operating the vacuum system lowers the water table in a portion of the soil and groundwater region adjacent the conduit.

17. The method of claim 11 wherein the remediating fluid flows downwardly in the first chamber and the fluid and vapor from the soil and groundwater region flows upwardly in the second chamber.

18. The method of claim 14 wherein the allowing the remediating fluid to mix and react with contaminants comprises a time delay between the injecting the remediating fluid and the reengaging the vacuum system.
